(19) United States
(12) Patent Application Publication
(10) Pub. No.: US 2021/0283936 A1
(43) Pub. Date: Sep. 16, 2021

(54) IMAGING MEDIA

(71) Applicant: Hewlett-Packard Development Company, L.P., Spring, TX (US)

(72) Inventors: Christopher Toles, Corvallis, OR (US); Michael W. Cumbie, Corvallis, OR (US); Jayprakash C. Bhatt, Corvallis, OR (US); Juan Carlos Vives, San Diego, CA (US)

(73) Assignee: Hewlett-Packard Development Company, L.P., Spring, TX (US)

(21) Appl. No.: 17/059,711

(22) PCT Filed: Dec. 6, 2018
(86) PCT No.: PCT/US2018/064354

§ 371 Date: Nov. 30, 2020

(51) Int. Cl. B41M 5/50; B41J 2/21

(52) U.S. Cl. CPC B41M 5/502; B41J 2/2114

(57) ABSTRACT

The present disclosure is drawn to imaging media. In one example, an imaging medium includes a substrate, a color layer on the substrate, and an opaque porous concealing layer over the color layer. The color layer includes a pattern of color regions, wherein individual color regions include multiple adjacently-applied colors. The opaque porous concealing layer has a coat weight from 2 gsm to 10 gsm. The opaque porous concealing layer includes transparent inorganic particles having a refractive index from 1.3 to 3, and void spaces between the transparent inorganic particles are occupied by air.

### BACKGROUND

There are several reasons that inkjet printing has become a popular way of recording images on various media surfaces. Some of these reasons include low printer noise, variable content recording, capability of high speed recording, and multi-color recording. Additionally, these features can be obtained at a relatively low price to consumers. Consumer demand can create pressure to develop inkjet printing systems and inks that can print on a wide variety of media quickly and with good image quality. Various types of specialty media have been developed for use with inkjet printing to provide better performance or features in certain printing applications.

### BRIEF DESCRIPTION OF THE DRAWING

FIG. 1 is a cross-sectional view illustrating an example imaging medium in accordance with examples of the present disclosure;

FIG. 2 is a top down view of an example color layer of an imaging medium in accordance with examples of the present disclosure;

FIG. 3 is a top down view of another example color layer of an imaging medium in accordance with examples of the present disclosure;

FIG. 4 is a top down view of yet another example color layer of an imaging medium in accordance with examples of the present disclosure;

FIG. 5 is a top down view of another example color layer of an imaging medium in accordance with examples of the present disclosure;

FIG. 6 is a top down view of still another example color layer of an imaging medium in accordance with examples of the present disclosure;

FIGS. 7A-7C show a cross-sectional view of an example imaging medium being printed with a transparent ink in accordance with examples of the present disclosure;

FIG. 8 is a schematic view of an example imaging system in accordance with examples of the present disclosure; and

FIG. 9 is a flowchart illustration an example method of making an imaging medium in accordance with examples of the present disclosure.

### DETAILED DESCRIPTION

The present disclosure describes imaging media, imaging systems, and methods of making imaging media. In one example, an imaging medium includes a substrate, a color layer on the substrate, and an opaque porous concealing layer over the color layer. The color layer includes a pattern of color regions, where individual color regions include multiple adjacently-applied colors. The opaque porous concealing layer has a coat weight from 2 grams per square meter to 10 grams per square meter, and the opaque porous concealing layer includes transparent inorganic particles having a refractive index from 1.3 to 3. Void spaces between the transparent inorganic particles are occupied by air. In certain examples, the transparent inorganic particles can include silica, alumina, pseudoboehmite, precipitated calcium carbonate, aluminum trihydroxide, zeolite, or a combination thereof. In other examples, the pattern can be a repeating pattern of color regions, where the color regions include: three or more adjacent stripes of different colors; four or more spots including a two by two grid configuration of different colors; or nine or more spots including a three by three grid configuration of different colors. In certain examples, the multiple adjacently-applied colors can include cyan, magenta, and yellow. In further examples, the multiple adjacently-applied colors can be individually applied at a width from 15 μm to 100 μm. In still further examples, the imaging medium can include a machine-readable registration mark on the porous concealing layer.

The present disclosure also extends to imaging systems. In one example, an imaging system includes an imaging medium and a transparent ink. The imaging medium includes a substrate, a color layer on the substrate, and an opaque porous concealing layer over the color layer. The color layer includes a pattern of color regions, where individual color regions include multiple adjacently-applied colors. The opaque porous concealing layer has a coat weight from 2 grams per square meter to 10 grams per square meter, and the opaque porous concealing layer includes transparent particles having a refractive index from 1.3 to 3. Void spaces between the transparent particles are occupied by air. The transparent ink includes a polymer having a dry refractive index within 0.1 of a refractive index of the transparent particles. In certain examples, the transparent particles can include polymer particles, silica, alumina, pseudoboehmite, precipitated calcium carbonate, aluminum trihydroxide, zeolite, or a combination thereof. In other examples, the polymer of the transparent ink can include poly(t-butyl) methacrylate, polyvinyl alcohol, poly(ethyl methacrylate), polyvinyl butyral, polymethyl methacrylate, methyl cellulose, polyimide, or a combination thereof. In further examples, the transparent ink can be loaded within or fluidly coupled to an inkjet printhead to selectively print the transparent ink onto the imaging medium. In still further examples, the system can include a black ink loaded within or fluidly coupled to a second inkjet printhead to print black ink onto the imaging medium. In other examples, a method of forming an image using the imaging system can include jetting the transparent ink onto the opaque porous concealing layer. The polymer of the transparent ink can penetrate into the void spaces between the transparent particles to reduce the opacity of a portion of the concealing layer to allow color from the color layer to be visible through the portion.

The present disclosure also extends to methods of making imaging media. In one example, a method of making an imaging medium includes applying a color layer on a substrate. The color layer includes a pattern of color regions, where individual color regions include multiple adjacently-applied colors. An opaque porous concealing layer is applied on the color layer. The opaque porous concealing layer includes inorganic transparent particles having a refractive index from 1.3 to 3. Void spaces between the inorganic transparent particles are occupied by air. In other examples, the opaque porous concealing layer can be applied at a coat weight from 2 grams per square meter to 10 grams per square meter when dried. In further examples, a machine-readable registration mark can be printed on the porous concealing layer.

In some examples, the imaging media, systems, and methods described herein can be used to record full-color images using a single inkjet ink. This can be useful in certain printing applications where printing with a single ink can be simpler, easier, or cheaper than printing multiple colored inks. In certain examples, a transparent ink can be printed on the imaging media described herein to selectively reveal colors in the color layer beneath the opaque porous concealing layer. Printing the transparent ink from a single printhead can be useful in label printing, packaging workflows, and other applications where using a single printhead is more efficient than using multiple printheads.

Generally, images can be formed on the imaging media by selectively reducing the opacity of the opaque porous concealing layer to reveal colors from the colored layer below. The opaque porous concealing layer can include transparent particles having a relatively high refractive index compared to air. Because air occupies pores between the transparent particles, the particles can have a strong scattering effect on light passing through the layer. Most light can be scattered and reflected back off the opaque porous concealing layer, which can cause the layer to appear opaque and white. The transparent ink can include a transparent polymer that has approximately the same refractive index as the transparent particles in the opaque porous concealing layer. When the transparent ink is printed on the media, the transparent polymer can fill in the pores that were occupied by air. Because the transparent polymer more closely matches the refractive index of the transparent particles, the light scattering in the opaque porous concealing layer decreases, making the layer appear more transparent. Thus, the color beneath the layer can show through. The colored layer can include multiple colors in a specific pattern, such as stripes or pixels, so that a full color image can be formed by revealing the appropriate colors at many locations across the media.

In some examples, the transparent ink can be printed using an inkjet printhead, which can print at high resolutions such as 11300^{th} inch, 11600^{th} inch, or 1/1200^{th} inch, for example. In certain examples, the colored layer can include multiple colors printed in a pattern such as stripes or a grid with the individual colors having a width corresponding to the print resolution. Thus, high resolution full-color images can be formed by selectively printing the transparent ink on the media to reveal particular colors beneath the opaque porous concealing layer.

In further examples, the opaque porous concealing layer can be designed so that the layer appears opaque before the transparent ink is printed on the layer. The opaque porous concealing layer can then become more transparent when the transparent ink is printed and dried on the layer. The transparent ink includes a transparent polymer that has a refractive index near the refractive index of the transparent particles in the opaque porous concealing layer. In some cases, the transparent polymer can be in the form of a dispersion of polymer particles. The polymer particles can have a particle size small enough to penetrate into the void spaces between the transparent particles of the opaque porous concealing layer. The polymer particles may also have a relatively low minimum film forming temperature, so that after printing the particles can coalesce into a continuous film under moderate heating. When the transparent polymer from the transparent ink forms a continuous film around the transparent particles of the opaque porous concealing layer, the combination of the two materials can cause less light scattering and thereby become more transparent. In other examples, the transparent polymer can be a soluble polymer that is dissolved in the transparent ink. When the transparent ink is printed and dried, the transparent polymer can form a dry film around the transparent particles of the opaque porous concealing layer.

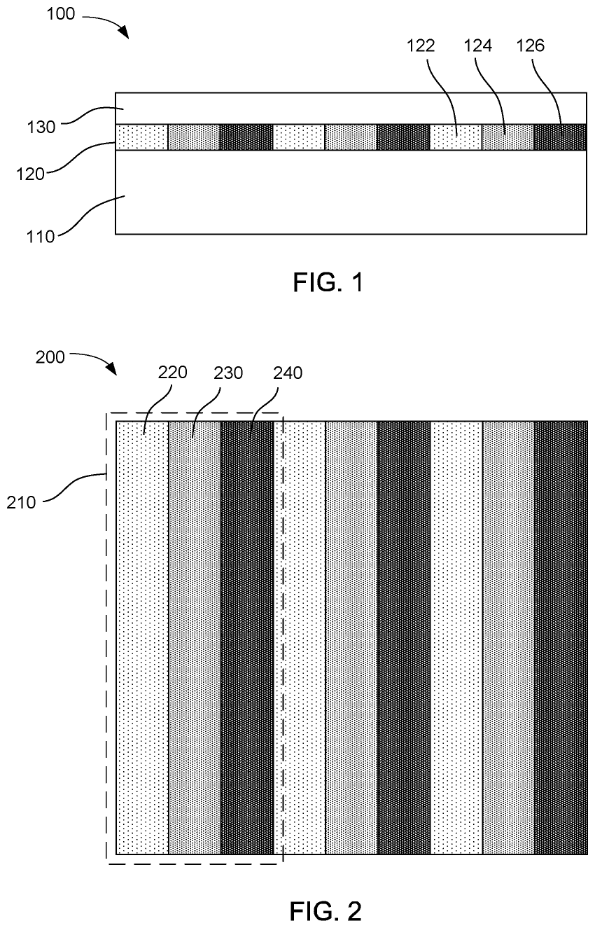

To further illustrate the imaging media described herein, FIG. 1 shows a cross sectional schematic view of an example imaging medium 100 in accordance with examples of the present disclosure. The imaging medium includes a substrate 110, a color layer 120 on the substrate, and an opaque porous concealing layer 130 over the color layer. The opaque porous concealing layer includes transparent inorganic particles having a refractive index from 1.3 to 3 and void spaces between the particles occupied by air (not shown in the figure). The color layer in this example includes a pattern of color regions, where the color regions include three different colors 122, 124, 126 applied adjacent one to another.

The substrate can include any type of print media substrate, such as base paper, coated paper, polymer films, self-adhesive labels, cardboard, and so on. In certain examples, the substrate can include cellulose fibers and/or non-cellulose fibers, such as synthetic fibers. In some cases, the substrate can also include a polymeric binder. The polymeric binder can be included, for example, when either cellulose or synthetic fibers are used. The cellulose fibers can be made from hardwood or softwood species. The synthetic fibers can be made from polymerization of organic monomers. The substrate can be formed with a paper machine with a pulp, or the like. The substrate can also include other additives, such as a pigment dispersant, a thickener, a flow modifier, a defoamer, an antifoamer, a releasing agent, a foaming agent, a penetrant, a coloring dye, a coloring pigment, an optical brightener, an ultraviolet absorber, an antioxidant, a preservative, a fungicide, an insolubilizer, a wet strengthen agent, a dry paper strengthening agent, a sizing agent, or a combination thereof.

Although the thickness of the substrate is not particularly limited, in some examples the substrate can have a thickness of from about 50 μm to about 300 μm, and for example, from about 80 μm to about 250 μm. The form factor of the substrate can be any desired form factor, such as a sheet in a standard (e.g., A4 size, 8.5 inch by 11 inch size, etc.) or nonstandard size, a roll, a printable label, a printable packaging article, and so on.

In further examples, the color layer can be applied on the substrate by a printing process. The color layer can include multiple colors printed adjacently in a pattern. The colors can be formed by printing colored inks using any desired printing method. For example, the colors can be printed using a digital printing method such as inkjet printing, electrophotographic printing, and so on. In other examples, the colors can be printed using an analog printed method such as gravure printing, flexographic printing, lithographic printing, and so on.

The colored inks used to form the color layer can vary in composition depending on the type of printing used to form the color layer. Generally, the colored inks can include a colorant and a binder. In some examples, the colorant can be a pigment, a dye, or a combination thereof. The colorant can include a cyan colorant, a magenta colorant, a yellow colorant, a black colorant, or other colorants. In further examples, the binder can include a polymer such as polyvinyl alcohol, a latex, polyurethane, or others. Other ingredients in the colored inks can include a liquid vehicle, a surfactant, additives to inhibit the growth of microorganisms, viscosity modifiers, materials for pH adjustment, sequestering agents, anti-kogation agents, preservatives, and the like. In some examples, the liquid vehicle can be an aqueous liquid vehicle that includes water. In further examples, the liquid vehicle can include water and a co-solvent.

The color layer includes a pattern of color regions, wherein individual color regions include multiple adjacently-applied colors. FIG. 2 shows a top-down view of an example color layer 200 in accordance with examples of the present disclosure. In this example, the color layer includes a pattern of color regions 210. One of the color regions is marked inside a dashed box in the figure. The color region includes three color stripes 220, 230, 240. These three stripes are repeated across the entire color layer to form a repeating pattern. It should be noted that the color layer shown in FIG. 2 is not drawn to scale, and in practice a color layer in accordance with the present disclosure can have a much greater number of color strips than are shown in the figure. In some examples, the color stripes can have a small width corresponding to the printing resolution of an inkjet printer used to print transparent ink onto the media. In certain examples, the color stripes can have a width of 1/150^{th} inch, 1/300^{th} inch, 1/600^{th} inch, or 1/1200^{th} inch, for example. In further examples, the color stripes can have a width from 15 μm to 100 μm. Thus, a large of number of such color stripes can be printed in the pattern shown in FIG. 2, repeated across an entire imaging medium. In this example, the three colors used can be cyan, magenta, and yellow. In other examples, other colors can be used. In a particular example, a similar pattern of stripes can be formed with four different colors repeated, and the four colors can include cyan, magenta, yellow, and black.

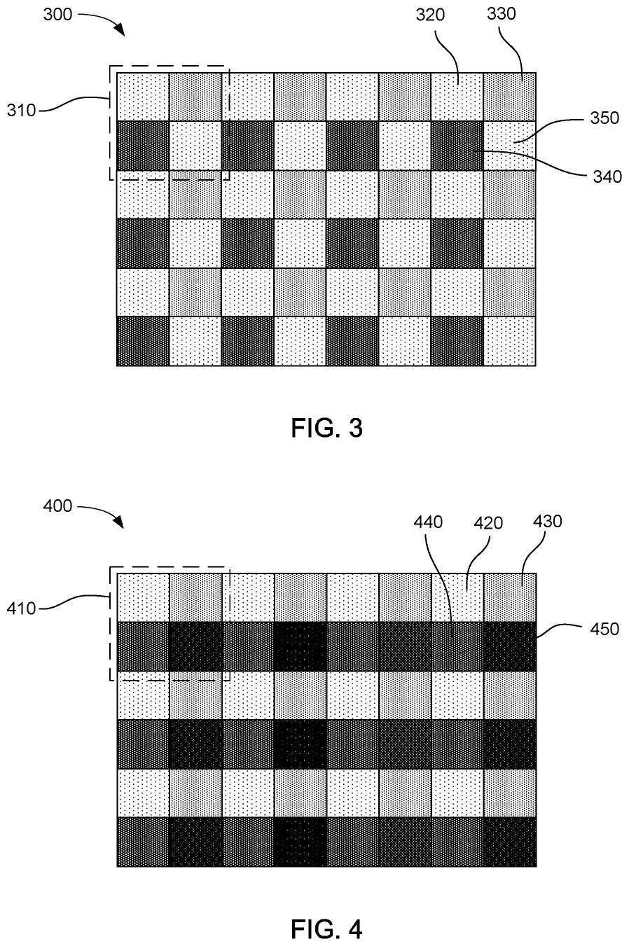

FIG. 3 shows a different example color layer 300. This example includes color regions 310 that include four colored spots 320, 330, 340, 350 in a two by two grid configuration. In this example, two of the colored spots 320, 350 are the same color. In a certain example, the two colored spots that are the same color can be yellow, while the other two colored spots can be cyan and magenta. The two by two grid pattern is repeated across the entire imaging medium.

FIG. 4 shows a similar example color layer 400 with color regions 410 that have a two by two grid pattern. In this example, the four colored spots 420, 430, 440, 450 include four different colors. In a particular example, the four colors can include cyan, magenta, yellow, and black. Including black with the other colors can allow the printed images on the imaging medium to have a wider range of values while printing with a single transparent ink.

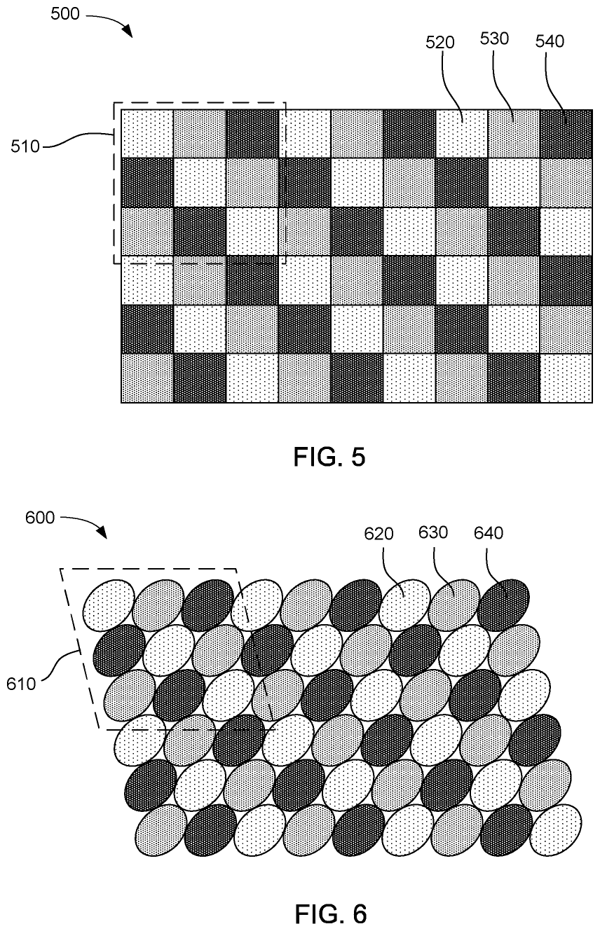

FIG. 5 shows yet another example color layer 500. This color layer includes color regions 510 that include nine colored spots in a three by three grid configuration. The colored spots include three different colors 520, 530, 540 in a pattern. In this example, the three colors can include cyan, magenta, and yellow.

FIG. 6 shows another example color layer 600. This color layer also includes color regions 610 with a three by three grid configuration. However, in this example the colored spots are in the form of ovals instead of squares. The colored spots include three colors 620, 630, 640, which can be cyan, magenta, and yellow.

The example color layers shown in the figures are merely a few specific examples of the color patterns that can be used in the color layer. A variety of other patterns can be used in addition to the stripe and grid patterns shown in the figures.

In various examples, the color layer can include multiple colors printed adjacently. As used herein, “adjacently” refers to two colors printed next to one another. This can include printed colors in areas that contact one another along an edge, or areas that overlap somewhat, or areas that are separated by a gap. In certain examples, two adjacent colors can overlap by up to 10% of the width of the colored areas. Thus, two stripes of different colors printed adjacently can overlap by up to 10% of the width of an individual stripe. In further examples, two adjacent colors can have a gap with a gap width up to 25% of the widths of the colored areas. Thus, two stripes printed adjacently can be separated by a gap of up to 25% the width of an individual stripe. An imaging medium made with a white substrate can thus have a relatively small amount of white space between the adjacent colored areas.

In certain examples, the multiple adjacently-applied colors in the color layer can include cyan, magenta, and yellow. In further examples, the colors can include cyan, magenta, yellow, and black. The width of the applied colors, whether in the form of strips, spots, or other shapes, can be from 15 μm to 100 μm. In other examples, the width can be from 20 μm to 50 μm. In various examples, the color regions in the color layer can include three or more adjacent stripes of different colors, four or more spots including a two by two grid configuration of different colors, or nine or more spots including a three by three grid configuration of different colors.

The opaque porous concealing layer is applied over the color layer on the imaging medium. The opaque porous concealing layer includes transparent particles having a refractive index from 1.3 to 3. In some examples, the transparent particles can be inorganic particles. The layer can also include void spaces between the transparent particles. These void spaces are occupied by air. Because of the difference between the refractive index of air and the refractive index of the transparent particles, the opaque porous concealing layer can have a strong light scattering effect, which makes the layer appear opaque.

The opaque porous concealing layer can be applied at a coat weight that is sufficient thick to make the layer appear opaque and conceal the colors of the color layer underneath. In general, the opaque porous concealing layer is applied at a coat weight of 2 gsm (grams per square meter) to 10 gsm. In further examples, the coat weight can be from 3 gsm to 8 gsm.

In certain examples, the transparent particles can be inorganic transparent particles. The inorganic transparent particles can include silica, alumina, pseudoboehmite, precipitated calcium carbonate, aluminum trihydroxide, zeolite, or a combination thereof. In other examples, the transparent particles can be made of a transparent polymer. The transparent polymer can include polyvinyl alcohol, poly(ethyl methacrylate), polyvinyl butyral, polymethyl methacrylate, methyl cellulose, polyimide, or a combination thereof.

The transparent particles of the opaque porous concealing layer can have an average particle size from 100 nm to 10,000 nm. In further examples, the transparent particles can have an average particle size from 300 nm to 10,000 nm. In some examples, the transparent particles can have a uniform particle size distribution.

In further examples, the opaque porous concealing layer can have a sufficient porosity and pore size distribution to make the layer appear opaque due to light scattering at the interfaces between transparent particles and air in the layer. At the same time, the porosity and pore size distribution can be sufficient to allow a transparent ink to penetrate into the pores so that the transparent polymer in the ink can fill in spaces between the transparent particles of the opaque porous concealing layer. In some examples, the opaque porous concealing layer can have a porosity from 10% to 80%. In other examples, the porosity can be from 10% to 50% or from 50% to 80%. As used herein, “porosity” refers to the volume fraction of the geometric volume of the opaque porous concealing layer that is void space, i.e., occupied by air. In further examples, the opaque porous concealing layer can have an average pore diameter from 0.01 micrometer to 10 micrometers.

Besides the transparent particles described above, the opaque porous concealing layer can also include a binder in some examples. The binder can be a polymer that holds the transparent particles together and helps the particles adhere to the color layer beneath. In some examples, the binder can include water soluble or water-dispersible binders. Water-soluble binders can include but are not limited to polyvinyl alcohols, water-soluble polyvinyl alcohol-poly(ethylene oxide) copolymers, water-soluble copolymers of polyvinyl alcohol and polyvinylamine, cationic polyvinyl alcohols, acetoacetylated polyvinyl alcohols, silyl-modified polyvinyl alcohols, polyvinyl acetates, polyvinylpyrrolidones, copolymers of polyvinylpyrrolidone and polyvinyl acetate, starches, modified starches (including oxidized starches and ethylated starches), water soluble cellulose derivatives (including carboxymethyl cellulose and hydroxyethyl cellulose), polyacrylamides, casein, gelatin, maleic anhydride resin, styrene-butadiene copolymer, acrylic polymers (including polymers and copolymers of acrylic and methacrylic acids), vinyl polymers (including ethylene-vinyl acetate copolymers) or combinations thereof. Examples of water dispersible binders can include acrylic polymers, acrylic copolymers, vinyl acetate latex, polyesters, vinylidene chloride latex, styrene-butadiene copolymer latex, styrene/n-butyl acrylate copolymer (such as, e.g., ACRONAL® S728, available from BASF Corp., Ludwigshafen, Germany), and/or acrylonitrile-butadiene copolymer latex. In some examples, the binder can be a transparent polymer. In further examples, the transparent polymer binder can have a refractive index close to the refractive index of the transparent particles. In one example, the binder can be a transparent polymer with a refractive index within 0.1 from the refractive index of the transparent particles.

In certain examples, the amount of binder in the opaque porous concealing layer can be from 1 wt % to 20 wt % based on the dry weight of the layer. In other examples, the amount of binder can be from 2 wt % to 15 wt % or from 3 wt % to 10 wt %. In a particular example, the opaque porous concealing layer can consist of the binder and the transparent particles. In other examples, the layer may include additional additives such as dispersants, surfactants, and so on. In some examples, the total amount of additives in addition to the binder and the transparent particles can be from 0.1 wt % to 5 wt %. In further examples, the amount of transparent particles in the opaque porous layer can be from 75 wt % to 99 wt %, from 80 wt % to 99 wt %, or from 90 wt % to 99 wt %.

As used herein, “opaque” and “opacity,” when used with respect to the opaque porous concealing layer, refer to the hiding power or ability of the layer to conceal the colors of the color layer below. The opacity can be quantified by calculating the contrast ratio of the layer using ASTM test method D2805. In some examples, the opaque porous concealing layer can have a contrast ratio of 80% to 100% before the transparent ink is printed on the layer. After the transparent ink is printed and dried on the opaque porous concealing layer, the contrast ratio can be less because the layer appears more transparent. In some examples, the contrast ratio of the layer after printing and drying the transparent ink can be from 0% to 50%, from 0% to 35%, or from 0% to 25%. Accordingly, lower contrast ratios correspond to more transparency.

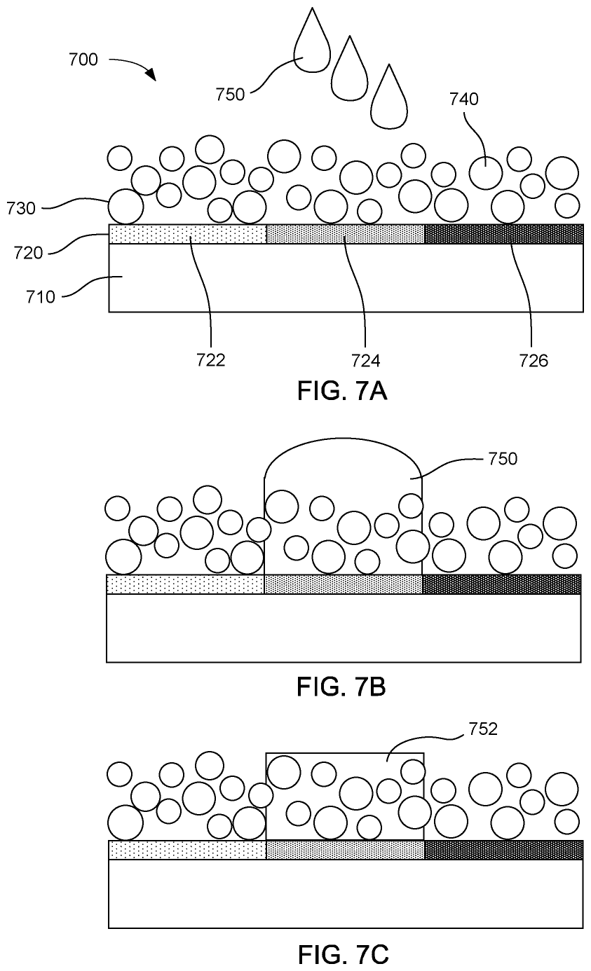

To illustrate the process of printing the transparent ink on the opaque porous concealing layer to allow the color beneath to show through, FIG. 7A shows a cross-sectional view of an imaging medium 700 with a transparent ink 750 being printed on the medium. The medium includes a substrate 710, a color layer 720, and an opaque porous concealing layer 730 including transparent particles 740. The color layer includes three color spots 722, 724, 726 of different colors printed adjacent one to another. The transparent ink in this example is jetted from an inkjet printhead onto the area over color spot 724. Before the ink is jetted onto the opaque porous concealing layer, the layer has an opaque appearance because of light scattering at the interfaces between the transparent particles and air in the void spaces between the particles. FIG. 7B shows the imaging medium after the transparent ink has been printed over the color spot 724, while the transparent ink is still wet. The transparent ink fills in the void spaces between the transparent particles of the opaque porous concealing layer. FIG. 7C shows the imaging medium after the transparent ink has dried. The transparent ink includes a transparent polymer, which forms a solid film 752 when the ink dries. The solid film fills in the void spaces between the transparent particles of the opaque porous concealing layer. This makes the opaque porous concealing layer become transparent in the area where the film has formed, so that the color of color spot 724 can be seen. The opaque porous concealing layer remains opaque over color spots 722 and 726, so that those colors are not visible.

In certain examples, registration marks can be added to the surface of the opaque porous concealing layer. The registration marks can be used to help an imaging system locate the correct areas for printing transparent ink to produce a particular visible color. In some cases, the registration marks can be colorless machine-readable registration marks. These can be formed by printing with a machine-detectable ink such as infrared ink, ultraviolet ink, and so on.

Imaging systems according to the present disclosure include an imaging medium and a transparent ink. The imaging medium can have any of the features and components described above. Generally, the imaging medium includes a substrate, a color layer on the substrate, wherein the color layer includes a pattern of color regions, wherein individual regions include multiple adjacently-applied colors, and an opaque porous concealing layer over the color layer. The opaque porous concealing layer is applied at a coat weight from 2 gsm to 10 gsm. The porous concealing layer includes transparent particles that have a refractive index from 1.3 to 3. Void spaces between the transparent particles are occupied by air. The transparent ink includes a polymer having a dry refractive index within 0.1 of the refractive index of the transparent particles.

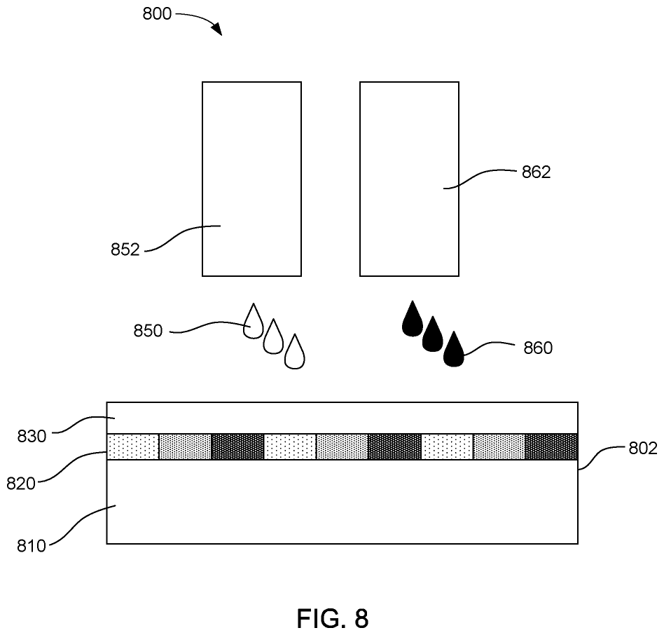

FIG. 8 shows an example imaging system 800. The system includes the imaging medium 802 with a substrate 810, color layer 820, and opaque porous concealing layer 830. The system also includes a transparent ink 850 as mentioned above. In this example, the transparent ink is printed from an inkjet printhead 852. This system also includes a black ink 860 printed from a second inkjet printhead 862. The transparent ink can be printed in specific locations to allow the colors of the color layer to show through, while the black ink can be printed in any location where black coloring is desired.

In various examples, the imaging media described herein can be used with imaging systems that include a single printhead for printing a transparent ink, or systems that include two printheads for printing a transparent ink and a black ink. In some examples, the imaging medium can be designed for use with a single printhead that prints transparent ink. In some such examples, the color layer of the imaging medium can include black as one of the colors present in the color layer. For example, the color layer can include four colors: cyan, magenta, yellow, and black. In other examples, the imaging medium can be designed for use with a transparent ink and a black ink. In some such examples, the color layer of the imaging medium can be devoid of black because black can be produced by printing the black ink. In certain examples, the color layer can include three colors: cyan, magenta, and yellow. The black ink can then be printed wherever black is desired in the image. These various systems, whether they systems include a single printhead or two printheads, can be simpler compared to full-color printing systems with separate printheads for every color.

In further examples, the imaging system can include a sensor for reading machine-readable registration marks on the imaging medium. Examples of the sensor can include a scanner, an electric eye, a contrast sensor, a luminescence sensor, and other types of photoelectric registration mark sensors.

The transparent inks described herein include a polymer having a dry refractive index within 0.1 of a refractive index of the transparent particles in the opaque porous concealing layer of the imaging media. Thus, when the polymer from the transparent ink fills in void spaces between the transparent particles, the combination of the transparent particles and the polymer can have a roughly uniform refractive index. In further examples, the polymer in the transparent ink can have a refractive index within 0.05 or 0.02 of the transparent particles.

In some examples, the polymer in the transparent ink can include poly(t-butyl) methacrylate, polyvinyl alcohol, poly(ethyl methacrylate), polyvinyl butyral, polymethyl methacrylate, methyl cellulose, polyimide, or a combination thereof. In various examples, the polymer can be in the form of a dispersion in the ink or a solution. In certain examples, the polymer can be dispersed as particles within a liquid ink vehicle. In such examples, the particles can have an average particles size that is small enough to fit between the transparent particles in the opaque porous concealing layer. The particles can also be film forming so that the particles form a continuous film after penetrating between the transparent particles. In certain examples, the polymer can have a minimum film forming temperature from 40° C. to 100° C. In such examples, the polymer particles can coalesce and form a film when the imaging medium is heated to a moderate temperature, such as when moderate heat is applied to dry the transparent ink after printing.

In other examples, the polymer can be soluble in the liquid vehicle of the transparent ink. The ink can penetrate between the transparent particles of the opaque porous concealing layer, and after the solvents in the ink evaporate during drying the polymer can be left as a continuous film filling in the void spaces between the transparent particles. Examples of solvents that can be included in the liquid vehicle of the transparent to dissolve polymers can include water, or water mixed with co-solvents and/or additional additives. In certain examples, water can be present in the inkjet ink composition in an amount of 30 wt % or greater, 40 wt % or greater, 50 wt % or greater, or 60 wt % or greater. In further examples, water can be present in an amount of at most 99 wt % or at most 95 wt %. In particular examples, water can be present in the inkjet ink composition in an amount of 30 wt % to 99 wt %, 40 wt % to 98 wt %, 50 wt % to 95 wt %, 60 wt % to 93 wt %, or 70 wt % to 90 wt %.

Co-solvents that may be used can include organic co-solvents, including alcohols (e.g., aliphatic alcohols, aromatic alcohols, polyhydric alcohols (e.g., diols), polyhydric alcohol derivatives, long chain alcohols, etc.), glycol ethers, polyglycol ethers, a nitrogen-containing solvent (e.g., pyrrolidinones, caprolactams, formamides, acetamides, etc.), and a sulfur-containing solvent. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C6-C12) of polyethylene glycol alkyl ethers, N-alkyl caprolactams, unsubstituted caprolactams, both substituted and unsubstituted formamides, both substituted and unsubstituted acetamides, and the like. Still other examples of suitable co-solvents include propylene carbonate and ethylene carbonate.

A single co-solvent may be used, or several co-solvents may be used in combination. When included, the co-solvent(s) can be present in total in an amount ranging from 0.1 wt % to 60 wt %, depending on the jetting architecture, though amounts outside of this range can also be used. In another example, the co-solvent(s) can be present in an amount from 1 wt % to 30 wt % or from 1 wt % to 20 wt % of the total weight of the transparent ink.

The transparent ink can typically be colorless. Therefore, in some examples the transparent ink can be devoid of colorants such as dyes or pigments. In other examples, the transparent ink may include a small amount of colorant but the amount can be small enough to allow the colors from the color layer of the imaging medium to be seen through the printed transparent ink.

In further examples, the transparent ink can include additional ingredients, such as additives to inhibit the growth of microorganisms, viscosity modifiers, materials for pH adjustment, sequestering agents, anti-kogation agents, preservatives, and the like. Such additives may be present in an amount of 0 to 5 wt % of the transparent ink.

The transparent ink may also include surfactants in some examples. Suitable surfactants may include non-ionic, cationic, and/or anionic surfactants. Examples include a silicone-free alkoxylated alcohol surfactant such as, for example, TECO® Wet 510 (Evonik Tego Chemie GmbH) and/or a self-emulsifiable wetting agent based on acetylenic diol chemistry, such as, for example, SURFYNOL® SE-F (Air Products and Chemicals, Inc.). Other suitable commercially available surfactants include SURFYNOL® 465 (ethoxylated acetylenic diol), SURFYNOL® CT 211 (non-ionic, alkylphenylethoxylate and solvent free), and SURFYNOL® 104 (non-ionic wetting agent based on acetylenic diol chemistry), (all of which are from Air Products and Chemicals, Inc.); ZONYL® FSO (a.k.a. CAPSTONE®, which is a water-soluble, ethoxylated non-ionic fluorosurfactant from Dupont); TERGITOL™ TMN-3 and TERGITOL™ TMN-6 (both of which are branched secondary alcohol ethoxylate, non-ionic surfactants), and TERGITOL™ 15-S-3, TERGITOL™ 15-S-5, and TERGITOL™ 15-S-7 (each of which is a secondary alcohol ethoxylate, non-ionic surfactant) (all of the TERGITOL™ surfactants are available from The Dow Chemical Co.). Fluorosurfactants may also be employed. When present, the surfactant can be present in the ink in an amount ranging from about 0.01 wt % to about 5 wt % based on the total wt % of the ink.

In some examples, the transparent ink can be loaded within or fluidly coupled to an inkjet printhead to selectively print the transparent ink onto the imaging medium. As used herein, “ink-jet” or “jet” refers to jetting architecture, such as ink-jet architecture. Ink-jet architecture can include thermal or piezo architecture. Additionally, such architecture can be configured to print varying drop sizes such as less than 10 picoliters, less than 20 picoliters, less than 30 picoliters, less than 40 picoliters, less than 50 picoliters, etc.

As mentioned above, in some examples an imaging system can include a black ink in addition to the transparent ink. In certain examples, the black ink can be loaded within or fluidly coupled to a second inkjet printhead to print the black ink onto the imaging medium. The second inkjet printhead for printing black ink can operate in the same way as the inkjet printhead for printing the transparent ink.

The black ink can include a black colorant, such as a black dye, black pigment, or combination thereof. Examples of black colorants can include the following pigments available from Degussa Corp.: Color Black FWI, Color Black FW2, Color Black FW2V, Color Black 18, Color Black, FW200, Color Black 5150, Color Black S160, and Color Black 5170. The following black pigments are available from Cabot Corp.: REGAL® 400R, REGAL® 330R, REGAL® 660R, MOGUL® L, BLACK PEARLS® L, MONARCH® 1400, MONARCH® 1300, MONARCH® 1100, MONARCH® 1000, MONARCH® 900, MONARCH® 880, MONARCH® 800, and MONARCH® 700. The following pigments are available from Orion Engineered Carbons GMBH: PRINTEX® U, PRINTEX® V, PRINTEX® 140U, PRINTEX® 140V, PRINTEX® 35, Color Black FW 200, Color Black FW 2, Color Black FW 2V, Color Black FW 1, Color Black FW 18, Color Black S 160, Color Black S 170, Special Black 6, Special Black 5, Special Black 4A, and Special Black 4. Other black pigments and dyes can also be included in the black ink.

The black can include a binder and other ingredients to increase jetting performance, similar to the transparent ink. In some examples, the black ink can include any of the binders, solvents, co-solvents, surfactants, dispersants, viscosity modifiers, sequestering agents, anti-kogation agents, preservatives, and other ingredients described above with respect to the transparent ink.

In another example, the present disclosure can include a method of forming an image using the imaging systems described above. The method can include jetting the transparent ink onto the opaque porous concealing layer. The polymer of the transparent ink can penetrate into the void spaces between the transparent particles to reduce the opacity of a portion of the opaque porous concealing layer to allow color from the color layer to be visible through the portion.

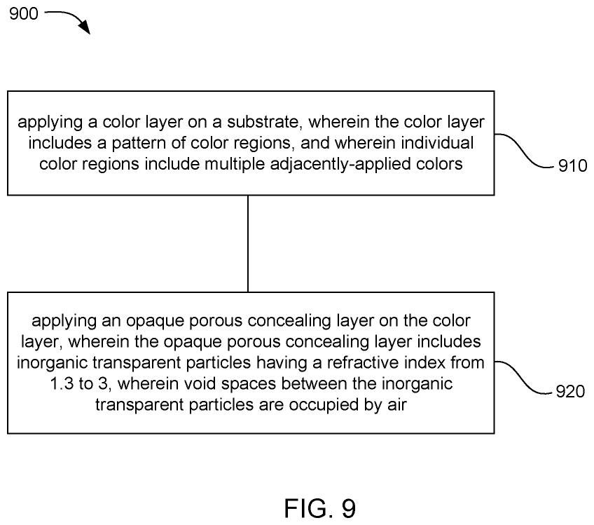

In further examples, the present disclosure can include methods of making the imaging media. FIG. 9 shows a flowchart of one example method of making an imaging medium 900. The method includes applying 910 a color layer on a substrate, wherein individual color regions include multiple adjacently-applied colors; and applying 920 an opaque porous concealing layer on the color layer, wherein the opaque porous concealing layer includes inorganic transparent particles having a refractive index from 1.3 to 3, wherein void spaces between the inorganic transparent particles are occupied by air. In certain examples, the opaque porous concealing layer can be applied at a coat weight from 2 gsm to 10 gsm when dried. In other examples, the method can also include printing a machine-readable registration mark on the opaque porous concealing layer. In still other examples, the method can include making the imaging medium with any of ingredients and properties described above.

As mentioned above, the color layer can be formed by printing the color regions using any suitable printing method. The opaque porous concealing layer can be applied using any suitable coating method. In some examples, the opaque porous concealing layer can be formed from a composition including the transparent particles, binder, and a solvent. The composition can be coated at the desired coat weight and dried to form the opaque porous concealing layer.

It is noted that, as used in this specification and the appended claims, the singular forms “a,” “an,” and “the” include plural referents unless the content clearly dictates otherwise.

The term “about” as used herein, when referring to a numerical value or range, allows for a degree of variability in the value or range, for example, within 5% or other reasonable added range breadth of a stated value or of a stated limit of a range. The term “about” when modifying a numerical range is also understood to include the exact numerical value indicated, e.g., the range of about 1 wt % to about 5 wt % includes 1 wt % to 5 wt % as an explicitly supported sub-range.

As used herein, “average particle size” refers to a number average of the diameter of the particles for spherical particles, or a number average of the volume equivalent sphere diameter for non-spherical particles. The volume equivalent sphere diameter is the diameter of a sphere having the same volume as the particle. Average particle size can be measured using a particle analyzer such as the Mastersizer™ 3000 available from Malvern Panalytical. The particle analyzer can measure particle size using laser diffraction. A laser beam can pass through a sample of particles and the angular variation in intensity of light scattered by the particles can be measured. Larger particles scatter light at smaller angles, while small particles scatter light at larger angles. The particle analyzer can then analyze the angular scattering data to calculate the size of the particles using the Mie theory of light scattering. The particle size can be reported as a volume equivalent sphere diameter.

As used herein, “liquid vehicle” or “ink vehicle” refers to a liquid fluid in an ink. A wide variety of ink vehicles may be used with the systems and methods of the present disclosure. Such ink vehicles may include a mixture of a variety of different agents, including, surfactants, solvents, co-solvents, anti-kogation agents, buffers, biocides, sequestering agents, viscosity modifiers, surface-active agents, water, etc.

As used herein, “colorant” can include dyes and/or pigments.

As used herein, “dye” refers to compounds or molecules that absorb electromagnetic radiation or certain wavelengths thereof. Dyes can impart a visible color to an ink if the dyes absorb wavelengths in the visible spectrum.

As used herein, “pigment” generally includes pigment colorants, magnetic particles, aluminas, silicas, and/or other ceramics, organo-metallics or other opaque particles, whether or not such particulates impart color. Thus, though the present description primarily exemplifies the use of pigment colorants, the term “pigment” can be used more generally to describe pigment colorants and other pigments such as organometallics, ferrites, ceramics, etc. In one specific example, however, the pigment is a pigment colorant

As used herein, a plurality of items, structural elements, compositional elements, and/or materials may be presented in a common list for convenience. However, these lists should be construed as though the individual members of the list are individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, and also to include all the individual numerical values or sub-ranges encompassed within that range as if individual numerical values and sub-ranges are explicitly recited. For example, a layer thickness from about 0.1 μm to about 0.5 μm should be interpreted to include the explicitly recited limits of 0.1 μm to 0.5 μm, and to include thicknesses such as about 0.1 μm and about 0.5 μm, as well as subranges such as about 0.2 μm to about 0.4 μm, about 0.2 μm to about 0.5 μm, about 0.1 μm to about 0.4 μm etc.

The following illustrates an example of the present disclosure. However, it is to be understood that the following is illustrative of the application of the principles of the present disclosure. Numerous modifications and alternative compositions, methods, and systems may be devised without departing from the spirit and scope of the present disclosure. The appended claims are intended to cover such modifications and arrangements.

### EXAMPLE

### Example 1—Making an Imaging Medium

An example imaging medium is prepared as follows:
1) An inkjet printer is used to print a series of colored stripes on a paper substrate. The colored stripes include a first cyan stripe, a second magenta stripe adjacent to the cyan stripe, and a third yellow stripe adjacent to the magenta stripe. This pattern is repeated across the width of the paper substrate. Each individual stripe has a width of 11300^{th} inch (about 85 μm).
2) After printing the colored stripes, an opaque porous concealing layer is coated over the colored stripes at a coat weight of 5 gsm. The opaque porous concealing layer includes transparent silica particles having an average particle size of 5 micrometers to 6 micrometers and a refractive index of 1.458 in an amount of 90 wt % with respect to the dry weight of the layer. The opaque porous concealing layer also includes Mowiol® 13-88 polyvinyl alcohol (available from Kuraray America, Inc.) as a binder in an amount of 10 wt % with respect to the dry weight of the layer.
3) Machine readable registration marks are printed at locations spaced across the imaging medium using a colorless infrared ink.

### Example 2—Forming an Image on the Imaging Medium

An image is formed on the imaging medium of Example 1 as follows:
1) A transparent ink is loaded in an inkjet printhead. The transparent ink includes poly (t-butyl methacrylate) with a refractive index of 1.4638 dispersed in a liquid ink vehicle.
2) The imaging medium is fed into a printer having a sensor for detecting the machine-readable registration marks. Based on the machine-readable registration marks, the printer determines the locations of the individual colored stripes in the color layer of the imaging medium.
3) The printer jets the transparent ink on specific locations to reveal the cyan, magenta, or yellow stripes below the opaque porous concealing layer in order to form the appropriate colors of a full-color image.
4) The printer jets a black ink from a second printhead in specific locations to provide black where appropriate in the full-color image.

What is claimed is:

1. An imaging medium, comprising:
a substrate;
a color layer on the substrate, wherein the color layer comprises a pattern of color regions, wherein individual color regions include multiple adjacently-applied colors; and
an opaque porous concealing layer over the color layer having a coat weight from 2 gsm to 10 gsm, wherein the opaque porous concealing layer comprises transparent inorganic particles having a refractive index from 1.3 to 3, wherein void spaces between the transparent inorganic particles are occupied by air.

2. The imaging medium of claim 1, wherein the transparent inorganic particles include silica, alumina, pseudoboehmite, precipitated calcium carbonate, aluminum trihydroxide, zeolite, or a combination thereof.

3. The imaging medium of claim 1, wherein the pattern is a repeating pattern of color regions, wherein the color regions include: three or more adjacent stripes of different colors; four or more spots including a two by two grid configuration of different colors; or nine or more spots including a three by three grid configuration of different colors.

4. The imaging medium of claim 1, wherein the multiple adjacently-applied colors include cyan, magenta, and yellow.

5. The imaging medium of claim 1, wherein the multiple adjacently-applied colors are individually applied at a width from 15 μm to 100 μm.

6. The imaging medium of claim 1, further comprising a machine-readable registration mark on the opaque porous concealing layer.

7. An imaging system, comprising:
an imaging medium, comprising:
a substrate;
a color layer on the substrate, wherein the color layer comprises a pattern of color regions, wherein individual color regions include multiple adjacently-applied colors; and
an opaque porous concealing layer over the color layer having a coat weight from 2 gsm to 10 gsm, wherein the opaque porous concealing layer comprises transparent particles having a refractive index from 1.3 to 3, wherein void spaces between the transparent particles are occupied by air; and
a transparent ink comprising a polymer having a dry refractive index within 0.1 of a refractive index of the transparent particles.

8. The imaging system of claim 7, wherein the transparent particles comprise polymer particles, silica, alumina, pseudoboehmite, precipitated calcium carbonate, aluminum trihydroxide, zeolite, or a combination thereof.

9. The imaging system of claim 7, wherein the polymer of the transparent ink is comprises poly(t-butyl) methacrylate, polyvinyl alcohol, poly(ethyl methacrylate), polyvinyl butyral, polymethyl methacrylate, methyl cellulose, polyimide, or a combination thereof.

10. The imaging system of claim 7, wherein the transparent ink is loaded within or fluidly coupled to an inkjet printhead to selectively print the transparent ink onto the imaging medium.

11. The imaging system of claim 10, further comprising a black ink loaded within or fluidly coupled to a second inkjet printhead to print black ink onto the imaging medium.

12. A method of forming an image using the imaging system of claim 7 comprising jetting the transparent ink onto the opaque porous concealing layer, wherein the polymer of the transparent ink penetrates into the void spaces between the transparent particles to reduce the opacity of a portion of the opaque porous concealing layer to allow color from the color layer to be visible through the portion.

13. A method of making an imaging medium, comprising:
to applying a color layer on a substrate, wherein the color layer comprises a pattern of color regions, and wherein individual color regions include multiple adjacently-applied colors; and
applying an opaque porous concealing layer on the color layer, wherein the opaque porous concealing layer comprises inorganic transparent particles having a refractive index from 1.3 to 3, wherein void spaces between the inorganic transparent particles are occupied by air.

14. The method of claim 13, wherein the opaque porous concealing layer is applied at a coat weight from 2 gsm to 10 gsm when dried.

15. The method of claim 13, further comprising printing a machine-readable registration mark on the opaque porous concealing layer.
